(19) United States
(12) Patent Application Publication
(10) Pub. No.: US 2005/0190968 A1
(43) Pub. Date: Sep. 1, 2005

(54) Image signal processing method and image signal processing circuit

(75) Inventors: Izumi Kanai, Machida-shi (JP); Muneki Ando, Isehara-shi (JP); Kousei Sugimoto, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/065,156

(22) Filed: Feb. 25, 2005

(30) Foreign Application Priority Data
Feb. 27, 2004 (JP) 2004-055405
Feb. 9, 2005 (JP) 2005-032913

(51) Int. Cl. G06K 9/00

(52) U.S. Cl. 382/169

(57) ABSTRACT

In order to improve a sense of contrast of an image signal without increasing the number of conversion conditions stored in advance, an image signal processing method of this invention includes steps of: dividing a range of possible values of input image signals into a plurality of regions, successively accumulating the number of image signals belonging to the respective regions among the image signals input during a predetermined period for the respective regions, and setting a successive accumulation result as an evaluation value; comparing the evaluation value with a predetermined value; selecting a conversion condition corresponding to a difference between the evaluation value and the predetermined value from among a plurality of conversion conditions stored in advance to correspond to one of the regions in which the evaluation value exceeds the predetermined value; and converting the image signals input under the selected conversion condition.

### BACKGROUND OF THE INVENTION

1. Field of the Invention

The present invention relates to an image signal processing technique.

2. Description of the Related Art

As a method for converting a gamma characteristic (γ-characteristic) according to an input image, a method disclosed in Japanese Patent Application Laid-Open No. 06-178153 is known. With this method, one of a plurality of gamma curves prepared in advance is selected based on counted histogram data, and the input image is subjected to a gamma conversion based on the selected gamma curve.

In an embodiment of this conventional technique, higher two bits of input image data are decoded to four categories of 00, 01, 10, and 11, and the number of histograms is counted in each category. In addition, the number of types of histogram data in each category is two (0 or 1) (hereinafter, an expression such as “a maximum histogram is 1” is used).

If so, the number of gamma curves prepared in advance is 2\hat{ }4=16 from a combination of binary values per category and four categories.

### SUMMARY OF THE INVENTION

Demand for a signal processing method capable of realizing a good conversion while suppressing the number of categories of histograms and a configuration for the method is rising.

It is an object of the present invention to satisfy such demand.

In order to achieve said object of the present invention, there is provided an image signal processing method comprising steps of: successively accumulating the number of image signals belonging to the respective regions among the image signals input during a predetermined period for the respective regions, and setting a successive accumulation result as an evaluation value in the state where a plurality of regions obtained by dividing a range of possible values of input image signals is set; comparing the evaluation value with a predetermined value; selecting a conversion condition corresponding to a difference between the evaluation value and the predetermined value from among a plurality of conversion conditions stored in advance to correspond to one of the regions in which the evaluation value exceeds the predetermined value; and converting the image signals input under the selected conversion condition.

To select the conversion condition corresponding to the difference between the evaluation value and the predetermined value, a configuration of making the selection by strictly calculating the difference between the evaluation value and the predetermined value can be adopted. Alternatively, various methods or configurations for enabling selecting the conversion condition corresponding to a relative relationship between the evaluation value and the predetermined value, such as a method or configuration of calculating the difference using an approximate value as at least one of the evaluation value and the predetermined value can be adopted.

When successively accumulating the number of image signals belonging to the respective regions and evaluating the image signals among the image signals input during a predetermined period, the number of image signals belonging to each of the respective regions may be counted for each region among the image signals input during the predetermined period, the obtained count value may be subjected to a processing such as normalization, and the count values for the respective regions may be successively accumulated and cumulatively added. Alternatively, the number of image signals belonging to each of the respective regions may be counted for each region among the image signals input during the predetermined period, the obtained count values for the respective regions may be successively accumulated and cumulatively added, and then the resultant value may be subjected to the processing such as the normalization.

Further, the image signals successively accumulated and evaluated for each of the respective regions are successively incremented or equal by successively accumulating the image signals for each region. Accordingly, if one of the plurality of monotonously incremented or equal evaluation values exceeds the threshold or if the predetermined value is greater than a maximum evaluation value among the evaluation values, the region in which the evaluation value exceeds the predetermined value is not present in the regions to which the input image signals belonging.

According to the present invention, a sense of contrast can be improved without increasing the number of conversion conditions for an image signal which are stored in advance.

### BRIEF DESCRIPTION OF THE DRAWINGS

FIG. 1 is a functional block diagram of an image signal processing apparatus according to an embodiment of the present invention;

FIGS. 2A and 2B are flowcharts that depict procedures for an image signal processing method according to an embodiment of the present invention;

FIG. 3 is a detailed view of a histogram counter;

FIG. 4 is a detailed view of a cumulative operation unit;

FIG. 5 depicts lower tone-side gamma curves;

FIG. 6 depicts higher tone-side gamma curves;

FIG. 7 depicts a processing performed by a selection unit 4 for selecting a lower tone-side curve;

FIG. 8 depicts a processing performed by the selection unit 4 for selecting a higher tone-side curve;

FIG. 9 is an explanatory view for a processing performed by a gamma generation unit; and

FIGS. 10A to 10D depict a process in which a certain input image is processed according to the present invention.

### DETAILED DESCRIPTION OF THE PREFERRED EMBODIMENTS

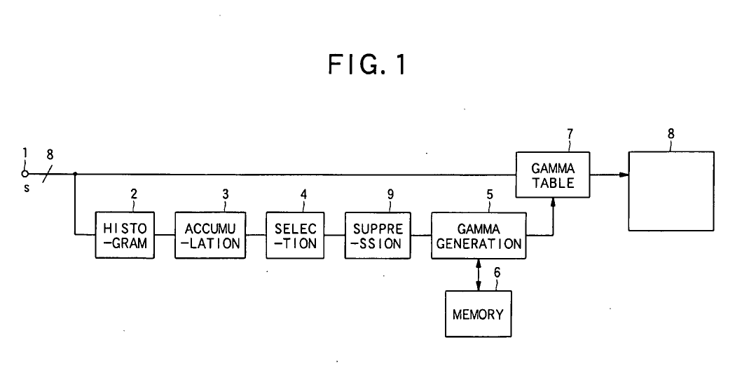

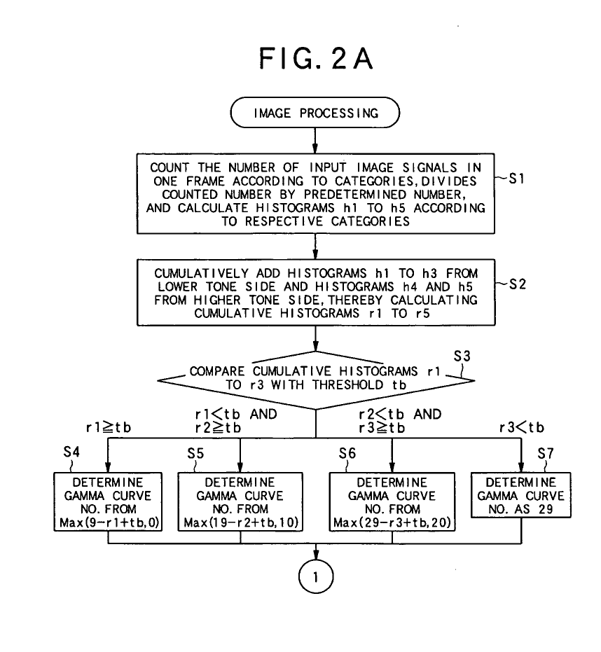

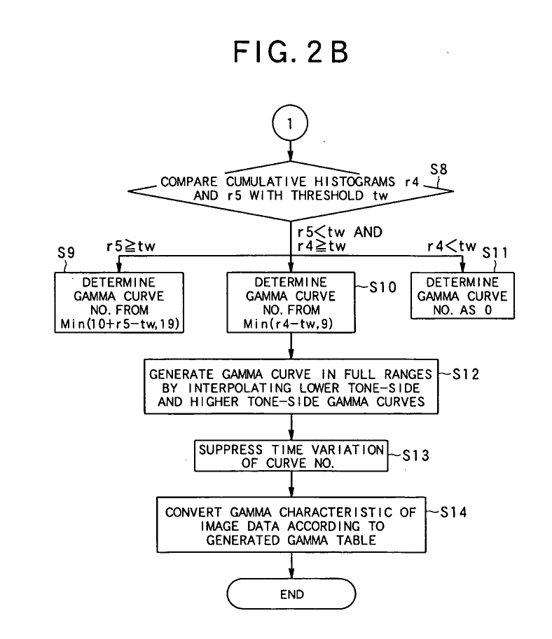

FIG. 1 is a functional block diagram of an image signal processing apparatus that realizes an image signal processing method according to an embodiment of the present invention. FIGS. 2A and 2B are flowcharts for explaining processing procedures for the image processing method according to the embodiment of the present invention.

Reference numeral 1 denotes an image data input terminal, 2 denotes a histogram counter, 3 denotes a cumulative operation unit, 4 denotes a selection unit, 9 denotes a suppression unit, 5 denotes a gamma generation unit, 6 denotes a memory, 7 denotes a gamma table, and 8 denotes a display apparatus.

Image data s such as luminance data (Y data) or RGB data is input to the input terminal 1. In this embodiment, it is assumed that the image data s is digital data of eight bits. For brevity of description, FIG. 1 shows that data input to the histogram counter 2 is equal to data input to the gamma table 5. However, the present invention is not limited to this. The luminance data may be input to the histogram counter 2 whereas the RGB data obtained by subjecting the luminance data to a color space conversion may be input to the gamma table 5.

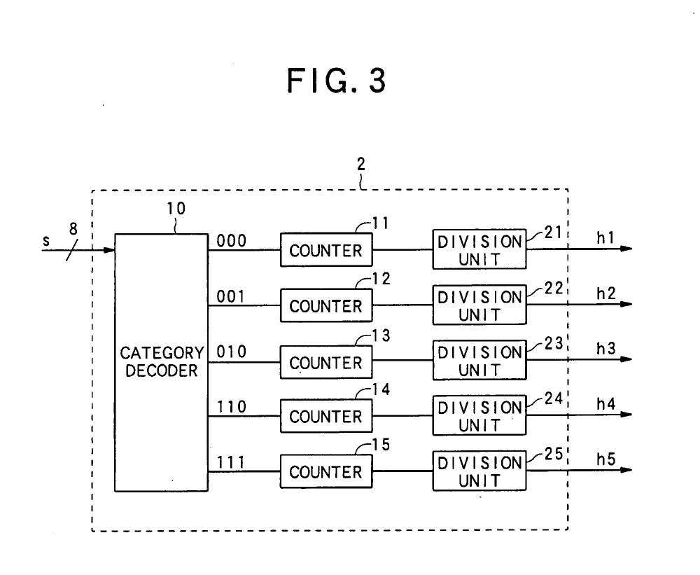

The histogram counter 2 counts the number of histograms corresponding to one frame of the input image data 1 (at a step S1). FIG. 3 shows a detailed view of the histogram counter 2. Reference numeral 10 denotes a category decoder, 11 to 15 denote counters, and 21 to 25 denote division units.

The image data s is input to the decoder 10, in which the image data s is category-decoded using higher three bits among the eight bits of data. The number of pixels having higher three bits of 000 (0 to 31 tones) is counted by the counter 11, the number of pixels having higher three bits of 001 (32 to 63 tones) is counted by the counter 12, and the number of pixels having higher three bits of 010 (64 to 95 tones) is counted by the counter 13. In addition, the number of pixels having higher three bits of 110 (192 to 223 tones) is counted by the counter 14, and the number of pixels having higher three bits of 111 (224 to 255 tones) is counted by the counter 15.

Normally, if an image signal is decoded using higher three bits of the signal, the number of histograms in eight categories of 000, 001, 010, 011, 100, 101, 110, and 111 is counted. In this embodiment, however, the number of histograms only in three lower tone-side categories (000, 001, and 010) and two higher tone-side categories (110 and 111), i.e., five categories in all are counted.

The counters 11 to 15 include latch circuits, not shown, respectively. When each of the respective counters 11 to 15 finishes counting the number of histograms corresponding to one frame, the counter outputs histogram data on one frame to each of the division units 21 to 25 in the next stage using a vertical synchronization signal.

Each of the division units 21 to 25 divides the histogram data corresponding to one frame and output from each of the counters 11 to 15 by a fixed value, thereby scaling the data to have an appropriate level as an address for selecting a gamma curve. This division may be a simple division. In this embodiment, bit shift is performed as the division.

If an input image size is assumed as 1920×1080 and each of the division units 21 to 25 shifts the input histogram data to the right by 15 bits (corresponding to division of the data by 32768), appropriate values as addresses can be obtained.

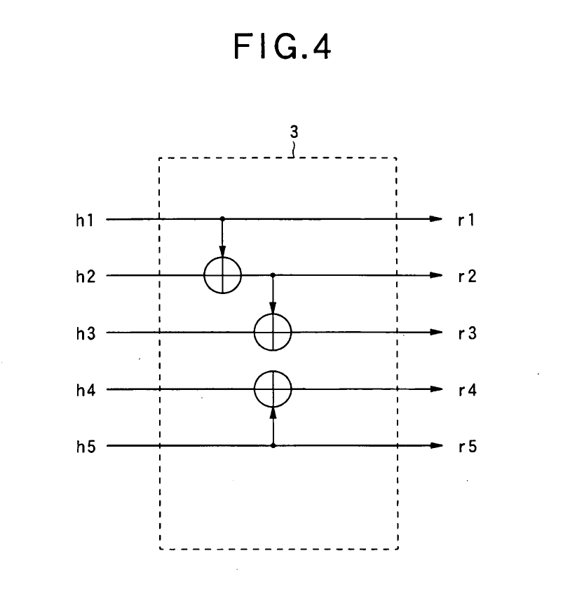

Pieces of histogram data h1 to h5 output from the histogram counter 2 are input to the cumulative operation unit 3 in the next stage. The pieces of histogram data h1 to h5 are input to the cumulative operation unit once per one frame, and the cumulative operation unit calculates cumulative data once per frame (at a step S2). FIG. 4 is a detailed view of the cumulative operation unit 3.

The cumulative operation unit 3 obtains pieces of cumulative data r1, r2, and r3 from the histogram h1, h2, and h3 in the three lower tone-side categories by the following calculation, respectively.
r1=h1
r2=h1+h2=r1+h2
r3=h1+h2+h3=r2+h3 (equations 1)

As for the histogram h4 and h5 in the two higher tone-side categories, a cumulative operation is performed from a higher tone side (255 tone side). As a result, the following pieces of cumulative data r4 and r5 are obtained.
r5=h5
r4=h5+h4=r5+h4 (equations 2)

The pieces of cumulative data thus calculated are output to the selection unit 4 in the next stage.

The selection unit 4 determines which gamma curve is to be used among a plurality of gamma curves prepared in the memory 6 in advance based on the cumulative data r1 to r5 output from the cumulative operation unit 3. The pieces of cumulative data r1 to r5 are output once per frame, and the selection unit 4, therefore, selects one gamma curve once per frame.

In this embodiment, it is assumed that 30 lower tone-side gamma curves (curve Nos. 0 to 29) that define outputs relative to inputs of 0 to 128 tones, and 20 higher tone-side gamma curves (curve Nos. 0 to 19) that define outputs relative to inputs of 192 to 255 tones are prepared. These gamma curves are stored in the memory 6. However, the number of the lower tone-side gamma curves and that of the higher tone-side gamma curves are not limited to these numbers. In addition, the number of the lower tone-side gamma curves may be equal to that of the higher tone-side gamma curves.

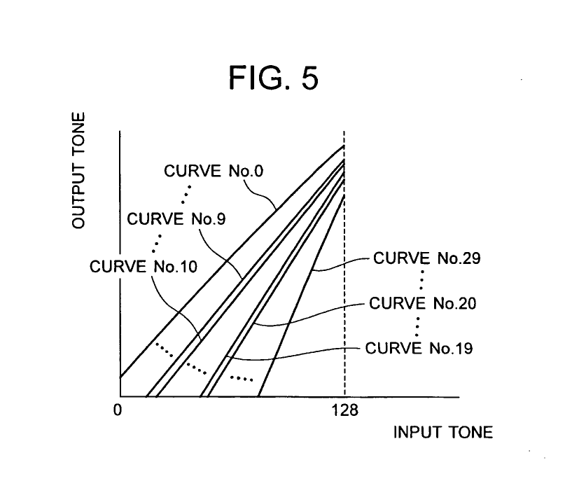

FIG. 5 depicts an example of the lower tone-side gamma curves. The lower tone-side gamma curves define output tones relative to 0 to 128 input tones. In this embodiment, the curve having a greater curve No. is a curve representing that a color is darker, and the curve having a smaller curve No. is a curve representing that a color is less dark. The curve Nos. 1 to 8 are set so as to be equally divided between the curve No. 0 and the curve No. 9, the curve Nos. 11 to 18 are set to be equally divided between the curve No. 10 and the curve No. 19, and the curve Nos. 21 to 28 are set to be equally divided between the curve No. 20 and the curve No. 29.

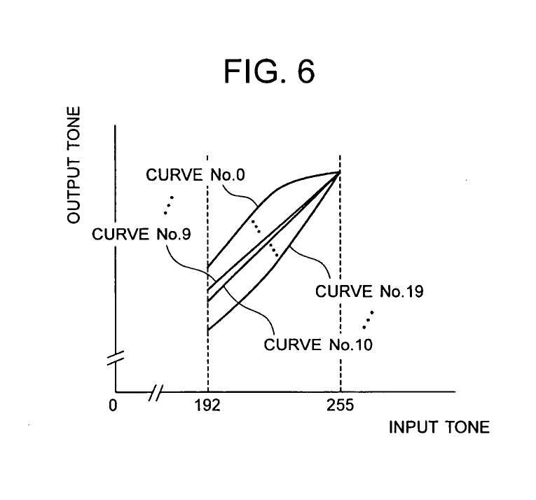

FIG. 6 depicts an example of the higher tone-side gamma curves. The higher tone-side gamma curves define output tones relative to 192 to 255 input tones. In this embodiment, the curve having a greater curve No. has a higher inclination, and the curve having a smaller curve No. has a lower inclination. The curve Nos. 1 to 8 are set so as to be equally divided between the curve No. 0 and the curve No. 9, and the curve Nos. 11 to 18 are set to be equally divided between the curve No. 10 and the curve No. 19.

Two thresholds of a lower tone-side threshold and a higher tone-side threshold are set into the selection unit 4 in advance. By comparing and operating these thresholds with the cumulative data r1 to r5, the selection unit 4 determines which curve No is to be selected. In this embodiment, the lower tone-side threshold is tb and the higher tone-side threshold is tw. Further, the selection unit 4 in this embodiment corresponds to a selection unit and a comparison unit according to the present invention.

<Lower Tone-Side Processing>

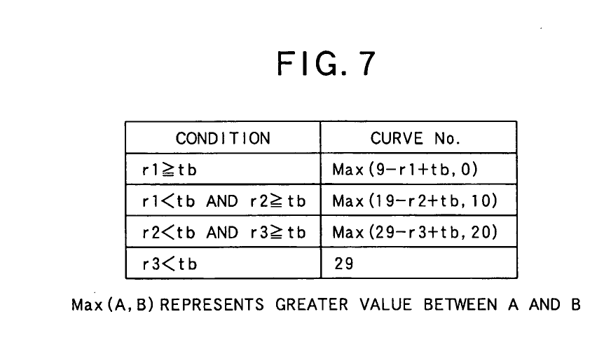

A processing for selecting a lower tone-side curve No. will first be described. FIG. 7 shows that the selection unit 4 compares the lower tone-side cumulative data r1 to r3 with the threshold tb (at a step S3) and that which curve No. the selection unit 4 selects based on a magnitude relationship. In FIG. 7, Max (A, B) represents a greater value between A and B.

[when r1>tb]

At r1>tb, in the category having the higher three bits 000, the cumulative histogram data r1 exceeds the threshold tb. Accordingly, the curve No. is selected from among a group of ten curves with curve Nos. 0 to 9 corresponding to this category (at a step S4). The selected curve No. is Max ([maximum curve No. in group]−r1+tb, [minimum curve No. in group]). In this case, the maximum curve No. in the group is 9 and the minimum curve No. in the group is 0, so that the selected curve No. is Max(9−r1+tb, 0). It is noted that [maximum curve No. in group]−r1+tb corresponds to a value obtained by subtracting (r1−tb), which is a difference between the threshold tb and the cumulative histogram data (r1 in this embodiment) exceeding the threshold tb from the maximum curve No. in the group.

The instance of r1≧tb corresponds to an instance in which a dark part has a higher frequency. If so, by selecting one of the curve Nos. 0 to 9, the curve representing that a color is less dark is selected. Further, the greater the cumulative data r1, the smaller the selected curve No. Therefore, the curve representing that a color is less dark is selected from the curve group (curve Nos. 0 to 9). Namely, if the cumulative histogram data exceeds the threshold in the lowest tone-side category, conditions of the curve Nos. 0 to 9 are choices as a plurality of conversion conditions for allocating a great tone difference to the lower tone-side regions. In addition, one conversion condition is selected from among a plurality of conversion conditions (curve Nos. 0 to 9) or choices according to the difference between the cumulative data and the threshold. Specifically, when two states in which the difference is small and the difference is large are compared, the curve representing that a color is less dark than in the former state, i.e., the curve in which the larger tone difference is allocated to the lower tone-side regions is selected in the latter state. The tone difference allocated to a certain tone region corresponds to a difference between a value obtained after a lowest tone in the tone region is converted and output under the selected conversion condition and a value obtained after a highest tone in the tone region is converted and output under the selected conversion condition.

[when r1<tb and r2≧tb]

At r1<tb and r2≧tb, in the category having the higher three bits 001, the cumulative histogram data r2 exceeds the threshold tb. Accordingly, the curve No. is selected from among a group of ten curves with curve Nos. 10 to 19 corresponding to this category (at a step S5). The selected curve No. is Max ([maximum curve No. in group]−r2+tb, [minimum curve No. in group]). In this case, the maximum curve No. in the group is 19 and the minimum curve No. in the group is 10, so that the selected curve No. is Max(19−r2+tb, 10). It is noted that [maximum curve No. in group]−r2+tb corresponds to a value obtained by subtracting (r2−tb), which is a difference between the threshold tb and the cumulative histogram data (r2 in this embodiment) exceeding the threshold tb from the maximum curve No. in the group.

The instance of r1<tb and r2≧tb corresponds to an instance in which a dark part has a certain frequency. If so, by selecting one of the curve Nos. 10 to 19, the curve representing that a color is slightly darker is selected. Further, the smaller the cumulative data r2, the greater the selected curve No. Therefore, the curve representing that a color is darker is selected from the curve group (curve Nos. 10 to 19). Namely, if the cumulative histogram data exceeds the threshold in the second lowest tone-side category, conditions of the curve Nos. 10 to 19 are choices as a plurality of conversion conditions in which the color is made darker than in the instance of r1>tb, i.e., a small tone difference is allocated to the lower tone-side regions. In addition, one conversion condition is selected from among a plurality of conversion conditions (curve Nos. 10 to 19) or choices according to the difference between the cumulative data and the threshold. Specifically, when two states in which the difference is small and the difference is large are compared, the curve representing that a color is less dark than in the former state, i.e., the curve for which the larger tone difference is allocated to the lower tone-side regions is selected in the latter state.

[when r2<tb and r3≧tb]

At r2<tb and r3≧tb, in the category having the higher three bits 010, the cumulative histogram data r3 exceeds the threshold tb. Accordingly, the curve No. is selected from among a group of ten curves with curve Nos. 20 to 29 corresponding to this category (at a step S6). The selected curve No. is Max ([maximum curve No. in group]−r3+tb, [minimum curve No. in group]). In this case, the maximum curve No. in the group is 29 and the minimum curve No. in the group is 20, so that the selected curve No. is Max(29−r3+tb, 20). It is noted that [maximum curve No. in group]−r3+tb corresponds to a value obtained by subtracting (r3−tb), which is a difference between the threshold tb and the cumulative histogram data (r3 in this embodiment) exceeding the threshold tb from the maximum curve No. in the group.

The instance of r2<tb and r3≧tb corresponds to an instance in which a dark part has a low frequency. If so, by selecting one of the curve Nos. 20 to 29, the curve representing that a color is darker is selected. Further, the smaller the cumulative data r3, the greater the selected curve No. Therefore, the curve representing that a color is darker is selected from the curve group (curve Nos. 20 to 29). Namely, if the cumulative histogram data exceeds the threshold in the third lowest tone-side category, conditions of the curve Nos. 20 to 29 are choices as a plurality of conversion conditions in which the color is made darkest, i.e., a smallest tone difference is allocated to the lower tone-side regions. In addition, one conversion condition is selected from among a plurality of conversion conditions (curve Nos. 20 to 29) or choices according to the difference between the cumulative data and the threshold. Specifically, when two states in which the difference is small and the difference is large are compared, the curve representing that a color is less dark than in the former state, i.e., the curve for which the larger tone difference is allocated to the lower tone-side regions is selected in the latter state.

[when r3<tb]

At r3<tb, the categories having the higher three bits 000 to 010 do not include the category in which the cumulative histogram data r1 to r3 exceed the threshold tb. The curve No. is, therefore, always 29 (at a step S7). The instance of r3<tb corresponds to an instance in which no data is present in the dark part. If so, the curve No. 29 of the curve representing that a color is darkest is selected.

<Higher Tone-Side Processing>

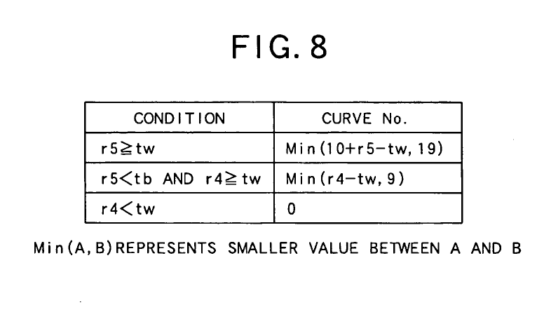

A processing for selecting a higher tone-side curve No. will first be described. FIG. 8 shows that the selection unit 4 compares the higher tone-side cumulative data r4 and r5 with the threshold tw (at a step 58) and that which curve No. the selection unit 4 selects based on a magnitude relationship. In FIG. 8, Min(A, B) represents a smaller value between A and B.

[when r5≧tw]

At r5≧tw, in the category having the higher three bits 111, the cumulative histogram data r5 exceeds the threshold tw. Accordingly, the curve No. is selected from among a group of ten curves with curve Nos. 10 to 19 corresponding to this category (at a step S9). The selected curve No. is Min ([minimum curve No. in group]+r5−tw, [maximum curve No. in group]). In this case, the minimum curve No. in the group is 10 and the maximum curve No. in the group is 19, so that the selected curve No. is Min(10+r5−tw, 19). It is noted that [minimum curve No. in group]+r5−tw corresponds to a value obtained by adding (r5−tw), which is a difference between the threshold tw and the cumulative histogram data (r5 in this embodiment) exceeding the threshold tw to the minimum curve No. in the group.

The instance of r5≧tw corresponds to an instance in which a bright part has a higher frequency. If so, by selecting one of the curve Nos. 10 to 19, the curve in which higher tone parts have higher inclinations is selected. Further, the greater the cumulative data r5, the greater the selected curve No. Therefore, the curve having a higher inclination is selected from the curve group (curve Nos. 10 to 19). Namely, if the cumulative histogram data exceeds the threshold in the highest tone-side category, conditions of the curve Nos. 10 to 19 are choices as a plurality of conversion conditions for allocating a greater tone difference to the higher tone-side regions. In addition, one conversion condition is selected from among a plurality of conversion conditions (curve Nos. 10 to 19) or choices according to the difference between the cumulative data and the threshold. Specifically, when two states in which the difference is small and the difference is large are compared, the curve having a higher inclination than in the former state, i.e., the curve in which the larger tone difference is allocated to the higher tone-side regions is selected in the latter state.

[when r5<tw and r4≧tw]

At r5<tw and r4≧tw, in the category having the higher three bits 110, the cumulative histogram data r4 exceeds the threshold tw. Accordingly, the curve No. is selected from among a group of ten curves with curve Nos. 0 to 9 corresponding to this category (at a step S10). The selected curve No. is Min ([minimum curve No. in group]+r4−tw, [maximum curve No. in group]). In this case, the minimum curve No. in the group is 0 and the maximum curve No. in the group is 9, so that the selected curve No. is Min(r4−tw, 9). It is noted that [minimum curve No. in group]+r4−tw corresponds to a value obtained by adding (r4−tw), which is a difference between the threshold tw and the cumulative histogram data (r4 in this embodiment) exceeding the threshold tw to the minimum curve No. in the group.

The instance of r5<tw and r4≧tw corresponds to an instance in which a bright part has a low frequency. If so, by selecting one of the curve Nos. 0 to 9, the curve in which the higher tone-side regions have lower inclinations is selected. Further, the smaller the cumulative data r4, the smaller the selected curve No. Therefore, the curve having a lower inclination is selected from the curve group (curve Nos. 0 to 9). Namely, if the cumulative histogram data exceeds the threshold in the second highest tone-side category, conditions of the curve Nos. 0 to 9 are choices as a plurality of conversion conditions in which a small tone difference is allocated to the higher tone-side regions. In addition, one conversion condition is selected from among a plurality of conversion conditions (curve Nos. 0 to 9) or choices according to the difference between the cumulative data and the threshold. Specifically, when two states in which the difference is small and the difference is large are compared, the curve having a higher inclination than in the former state, i.e., the curve in which the larger tone difference is allocated to the higher tone-side regions is selected in the latter state.

[when r4<tw]

At r4<tw, the categories having the higher three bits 110 to 111 do not include the category in which the cumulative histogram data r4 and r5 exceed the threshold tw. The curve No. is, therefore, always 0 (at a step S11). The instance of r4<tw corresponds to an instance in which no data is present in the bright part. If so, the curve No. 0 of the curve having the lowest inclination is selected.

The two curve Nos. on the lower tone side and the higher tone side selected by the selection unit 4 are input to the suppression unit 9 in the next stage. The suppression unit 9 suppresses time variations of the curve Nos. (at a step S12). In a moving image processing, curve Nos. selected by the selection unit 4 often greatly vary depending on frames and flickers often occur to the curves. To suppress the flickers, the suppression unit 9 suppresses the time variations of the curve Nos.

For example, if the lower tone-side curve No. C(i) in an i^{th} frame is input to the suppression unit 9, the suppression unit 9 performs the following processing and outputs a variation-suppressed display curve No. A(i).
A(i)=Avg(C(i−N)˜C(i−1)) (equation 3)

In the equation (3), A(i) denotes a display curve No. of a variation-suppressed in an i^{th} frame, Avg(x˜y) denotes an average of x to y, N denotes the number of previous frames to be referred to, and C(i) denotes a curve No. in the i^{th} frame selected by the selection unit 4.

Namely, the display curve No. corresponds to an average of curve Nos. in previous N frames. Thus, the curve No. is passed through a low-pass filter (LPF) in a time direction, whereby the time variation of the curve No. can be suppressed.

The equation (3) is shown as an example of calculating the lower tone-side curve No. The suppression unit 9 similarly processes the lower tone-side curve No. and the higher tone-side curve No.

By thus averaging the curve Nos. in the previous N frames, the variations of the curve Nos. can be suppressed and flickers can be suppressed, accordingly.

The two curve Nos. on the lower tone side and the higher tone side calculated by the suppression unit 9 are input to the gamma generation unit 5 in the next stage. The gamma generation unit 5 reads gamma curves at the curve Nos. selected by the selection unit 4 (a lower tone-side curve and a higher tone-side curve, i.e., two curves in all) from the memory 6. The two gamma curves thus read include only outputs corresponding to the 0 to 128 input tones and those corresponding to the 192 to 255 input tones, respectively. Due to this, outputs corresponding to 129 to 191 input tones between them are calculated (at a step S13). In this embodiment, linear interpolation is performed to calculate the outputs. However, the present invention is not limited to this and the gamma generation unit 5 may perform a polynomial interpolation, a spline interpolation, or the like as the interpolation operation.

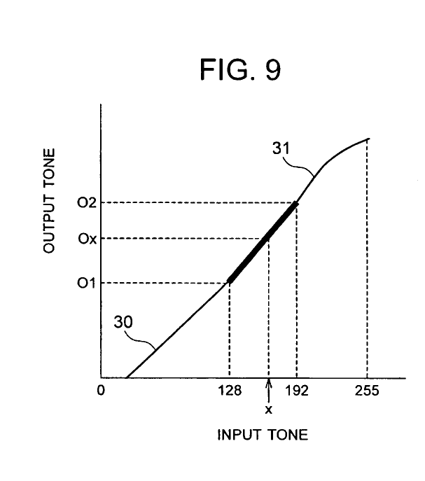

FIG. 9 is an explanatory view for the linear interpolation performed by the gamma generation unit. In FIG. 9, reference numeral 30 denotes the lower tone-side gamma curve selected by the selection unit 4 and 31 denotes the higher tone-side gamma curve selected by the selection unit 4 in a frame. The gamma generation unit 5 calculates outputs corresponding to inputs (129 to 191 input tones) between the gamma curves 30 and 31.

An output tone Ox corresponding to an input tone x is calculated as represented by the following equation (5).
Ox={(O2−O1)/(192−128)}×(x−128)+O1 (equation 5)

By thus calculating the outputs corresponding to the 129 to 191 input tones, the outputs corresponding to all 0 to 255 input tones can be obtained. This conversion characteristic is written to the gamma table 7. The conversion characteristic is written thereto once per frame using a vertical blanking interval.

The gamma characteristic of the image data s is converted by the gamma table 7 (corresponding to a conversion unit according to the present invention), a sense of contrast thereof is improved, and then the resultant image is displayed on the display unit 8 (at a step S14).

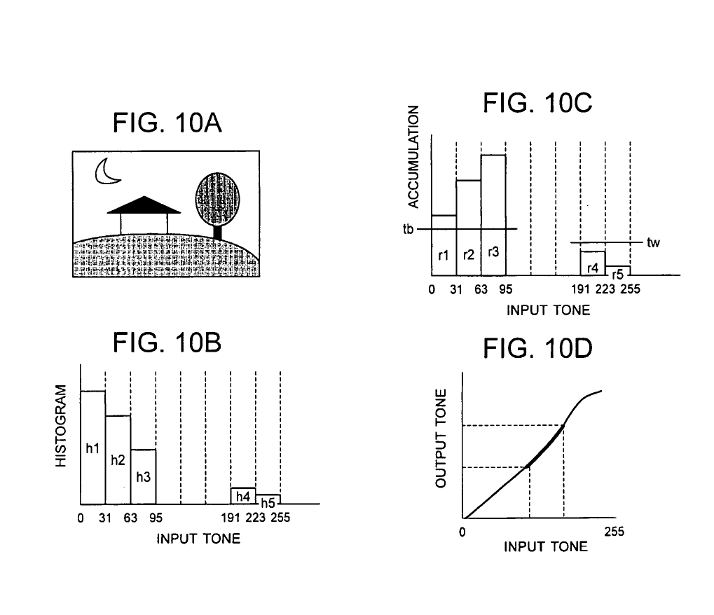

FIGS. 10A to 10D depict a process in which a certain image is processed by the above-stated configuration.

FIG. 10A depicts an input image. As shown in FIG. 10A, it is assumed herein that a relatively dark image is input. FIG. 10B depicts histogram data h1 to h5 on the image shown in FIG. 10A. It is assumed herein that the histogram data h1, h2, h3, h4, and h5 are 18, 15, 10, 4, and 3, respectively.

The pieces of cumulative data r1 to r5 are obtained by the calculations represented by the equations (1) and (2), that is, calculated as represented by the following Equations (6).
r1=h1=18
r2=r1+h2=18+15=33
r3=r2+h3=33+10=43
r5=h5=3
r4=r5+h4=7 (equations 6)

FIG. 10C depicts the cumulative data r1 to r5.

In this embodiment, it is assumed that the lower tone-side threshold tb is 15 (tb=15) and that the higher tone-side threshold tw is 10 (tw=10).

Since the relationship of r1≧tb is satisfied on the lower tone side, the lower tone-side curve No. is obtained as follows.
Max(9−r1+tb, 0)=Max(9−18+15, 0)=6 (equation 7)

As can be seen from FIG. 5, the curve at the curve No. 6 is a curve representing that a color is less dark. Since the image shown in FIG. 10A is a relatively dark image, such a curve is selected.

Since the relationship of r4<tw is satisfied on the higher tone side, the higher tone-side curve No. is 0. As shown in FIG. 6, the curve at the curve No. 0 is a curve having a lowest inclination. Since the image shown in FIG. 10A has a low brightness frequency, such a curve is selected.

The gamma generation unit 5 linearly interpolates the tones between the selected lower tone-side gamma curve and the selected higher tone-side gamma curve, and generates the conversion characteristic shown in FIG. 10D. As a result, if the image shown in FIG. 10A is input, the image is converted to have the characteristic that the lower tone side is not suppressed and the higher tone side is raised, making it possible to obtain a good sense of contrast.

This application claims priority from Japanese Patent Application No. 2004-55405 filed Feb. 27, 2004, and Japanese Patent Application No. 2005-32913 filed Feb. 9, 2005, which are hereby incorporated by reference herein.

1. An image signal processing method comprising steps of:
successively accumulating the number of image signals belonging to the respective regions among the image signals input during a predetermined period for the respective regions, and setting a successive. accumulation result as an evaluation value in the state where a plurality of regions obtained by dividing a range of possible values of input image signals is set;
comparing the evaluation value with a predetermined value;
selecting a conversion condition corresponding to a difference between the evaluation value and the predetermined value from among a plurality of conversion conditions stored in advance to correspond to one of the regions in which the evaluation value exceeds the predetermined value; and
converting the image signals input under the selected conversion condition.

2. An image signal processing method according to claim 1, further comprising a step of selecting a predetermined conversion condition stored in advance if no region in which the evaluation value exceeds the predetermined value is present.

3. An image signal processing method according to claim 1, wherein
at the step of selecting the one conversion condition from among said plurality of conversion conditions,
as the region in which the evaluation value exceeds the predetermined value is closer to a lower tone side or a higher tone side, said plurality of conversion conditions in which a tone difference is larger on the lower tone side or the higher tone side are selected, respectively; and
as the difference between the evaluation value and the predetermined value is larger, one of the conversion conditions in which the tone difference is large is selected from among said selected plurality of conversion conditions.

4. An image signal processing circuit comprising:
a cumulative operation unit in which a plurality of regions obtained by dividing a range of possible values of input image signals is set, that successively accumulates the number of image signals belonging to the respective regions among the image signals input during a predetermined period for the respective regions, and that sets a successive accumulation result as an evaluation value;
a comparison unit that compares the evaluation value with a predetermined value;
a selection unit that selects a conversion condition corresponding to a difference between the evaluation value and the predetermined value from among a plurality of conversion conditions stored in advance to correspond to one of the regions in which the evaluation value exceeds the predetermined value; and
a conversion unit that converts the image signals input under said selected conversion condition.

5. An image signal processing circuit according to claim 4, wherein
a predetermined conversion condition stored in advance is selected if no region in which the evaluation value exceeds the predetermined value is present.

6. An image signal processing circuit according to claim 5, wherein
the selection unit that selects the one conversion condition from among said plurality of conversion conditions
selects said plurality of conversion conditions in which a tone difference is larger on the lower tone side or the higher tone side, respectively as the region in which the evaluation value exceeds the predetermined value is closer to a lower tone side or a higher tone side, and
selects one of the conversion conditions in which the tone difference is large from among said selected plurality of conversion conditions as the difference between the evaluation value and the predetermined value is larger.
